(19) United States
(12) Patent Application Publication
(10) Pub. No.: US 2008/0127159 A1
(43) Pub. Date: May 29, 2008

(54) Multi-function peripheral device capable of independent firmware updating

(76) Inventor: Mark Van Regenmorter, Lake Forest, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/542,383

(22) Filed: Oct. 2, 2006

(51) Int. Cl. G06F 9/44

(52) U.S. Cl. 717/168

(57) ABSTRACT

A multi-function peripheral (MFP) device capable of independently updating the firmware thereof is disclosed. The MFP device includes a storage element configured to store firmware. The MFP also includes a network interface configured to connect with a firmware update location via a network. In addition, the MFP includes a processor configured to download a firmware update from the firmware update location via the network. The processor is further configured to install the firmware update, thereby updating the firmware.

### BACKGROUND OF THE INVENTION

1. Field of the Invention

The present invention relates to a multi-function peripheral device. More particularly, the present invention relates to updating the firmware of a multi-function peripheral device.

2. Description of the Related Technology

Recently, multi-function peripheral devices (MFPs) have been widely used for their convenience and versatility. Typically, MFPs include two or more of the following functions: copying, scanning, printing, faxing, and emailing.

An MFP has firmware which is a computer software program for performing various functions and operations thereof. Similar to other software programs, the firmware of an MFP may require updating to incorporate new features into the MFP. An update may also be provided for compatibility with another newly developed software program which can be used with an MFP. In certain cases, an update is provided to fix a defect in an MFP firmware.

Typically, a manufacturer of an MFP has a firmware update location for distributing firmware updates. In many cases, the firmware update location is a website accessible over the Internet. The manufacturer may keep a list of registered users and their email addresses. The manufacturer may distribute firmware update-related information to registered users by email. Alternatively, a user of an MFP may check with the manufacturer's website whether an update is available. In either case, a user downloads a firmware update from a firmware update location to a computer. The user then uploads the downloaded update from the computer to an MFP, and installs it on the MFP. This updating process is typically carried out using a computer connected to the MFP. For such a process, the computer may need a software program designed for firmware updating.

### SUMMARY OF CERTAIN INVENTIVE ASPECTS

One aspect of the invention provides a multi-function peripheral (MFP) device. The device comprises: a storage element configured to store firmware; a network interface configured to establish a data connection with a firmware update location via a network; and a processor configured to download a firmware update from the firmware update location via the network and configured to install the firmware update in the storage element, thereby updating the firmware.

The network interface may comprise a modem connectable to a telephone network. The network interface may comprise a network card connectable to a computer network. The network interface may be further configured to determine whether data received via the network is a firmware update from the firmware update location. The network interface may be further configured to establish a data connection with one of a plurality of firmware update locations, and the processor may be configured to select one of the firmware update locations for downloading the firmware update. The network interface may be configured to interface with a plurality of networks, and the processor may be configured to select one of the networks for downloading the firmware update.

The processor may be further configured to send a firmware update information inquiry to the firmware update location. The processor may be further configured to determine whether the firmware of the MFP requires updating. The processor may be further configured to automatically determine whether the firmware of the MFP requires updating. The processor may be further configured to periodically determine whether the firmware of the MFP requires updating. The processor may be further configured to download the firmware update upon receiving an update message provided from the firmware update location.

The device may further comprise a user interface configured to allow a user to set properties for downloading of a firmware update. The device may further comprise a user interface configured to allow a user to approve the downloading of the firmware update. The device may further comprise a user interface configured to allow a user to approve the installing of the firmware update. The multi-function capability of the MFP may comprise printer, scanner, emailing, photocopying, and facsimile functions.

Another aspect of the invention provides a multi-function peripheral (MFP) device, comprising: means for storing firmware; means for establishing a data connection with a firmware update location via a network; and means for downloading a firmware update from the firmware update location via the network and for installing the firmware update, thereby updating the firmware.

Yet another aspect of the invention provides a system for updating firmware of a multi-function peripheral (MFP) device. The system comprises: at least one firmware update location configured to store a firmware update; at least one network; and an MFP. The MFP comprises: a storage element configured to store firmware; a network interface configured to establish a data connection with the at least one firmware update location via the at least one network; and a processor configured to download the firmware update from one of the at least one firmware update location via one of the at least one network and configured to install the firmware update in the storage element, thereby updating the firmware.

The at least one network may comprise a telephone network. The network interface may comprise a modem connected to the telephone network. The at least one network may comprise a computer network. The network interface may comprise a network card connected to the computer network.

The network interface may be configured to communicate with one of the at least one firmware update location by a fax communication method. The network interface may be configured to communicate with one of the at least one firmware update location by a direct access communication method. The network interface may be configured to communicate with one of the at least one firmware update location by an email communication method. The network interface may be further configured to determine whether data received via the network is a firmware update from the at least one firmware update location.

The processor may be further configured to send a firmware update information inquiry to the at least one firmware update location. The processor may be further configured to determine whether the firmware of the MFP requires updating. The processor may be configured to automatically determine whether the firmware of the MFP requires updating. The processor may be configured to periodically determine whether the firmware of the MFP requires updating. The processor may be configured to download the firmware update upon receiving an update message provided from the at least one firmware update location.

The at least one firmware update location may comprise a plurality of firmware update locations, and the processor may be configured to select one of the firmware update locations for downloading the firmware update. The at least one network may comprise a plurality of networks, and the processor may be configured to select one of the networks for downloading the firmware update.

The MFP may further comprise a user interface configured to allow a user to set properties for downloading the firmware update. The MFP may further comprise a user interface configured to allow a user to approve the downloading of the firmware update. The MFP may further comprise a user interface configured to allow a user to approve the installing of the firmware update.

Another aspect of the invention provides a method of updating firmware of multi-function peripheral device (MFP). The method comprises: determining whether to update firmware of an MFP at the MFP; connecting the MFP to a firmware update location via a network, the firmware update location storing a firmware update; downloading the firmware update from the firmware update location to the MFP; and installing the firmware update, thereby updating the firmware.

The network may comprise at least one of a telephone network and a computer network. Determining whether to update the firmware may comprise: sending a firmware update information request from the MFP to the firmware update location; sending update version information from the firmware update location to the MFP; and comparing the update version information with version information of the firmware of the MFP at the MFP. Determining whether to update the firmware may be automatically initiated at the MFP. Determining whether to update the firmware may be periodically initiated at the MFP.

The method may further comprise sending an update message from the firmware update location to the MFP prior to determining whether to update the firmware, wherein determining whether to update the firmware is initiated upon receiving the update message. The firmware update may be received through one of a fax communication method, a direct access communication method, and an email communication method.

The method may further comprise determining whether data received via the network is a firmware update from the firmware update location. The method may further comprise providing a plurality of firmware update locations, wherein connecting the MFP to the firmware update location comprises selecting one of the firmware update locations. The method may further comprise providing a plurality of networks, wherein connecting the MFP to the firmware update location comprises selecting one of the networks. The method may further comprise allowing a user to set properties for determining whether to update the firmware or properties for downloading the firmware update. The method may further comprise allowing a user to approve the downloading of the firmware update or the installing of the firmware update.

### BRIEF DESCRIPTION OF THE DRAWINGS

FIG. 1 illustrates a system for updating a firmware of a multi-function peripheral device in accordance with one embodiment.

FIG. 2 is a schematic diagram of a multi-function peripheral device connected to a firmware update location via networks in accordance with another embodiment.

FIG. 3 is a flow chart of a method of updating a firmware of a multi-function peripheral device in accordance with another embodiment.

FIGS. 4A-4D illustrate a user interface of an MFP for updating a firmware in accordance with another embodiment.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements.

### System for Updating Firmware

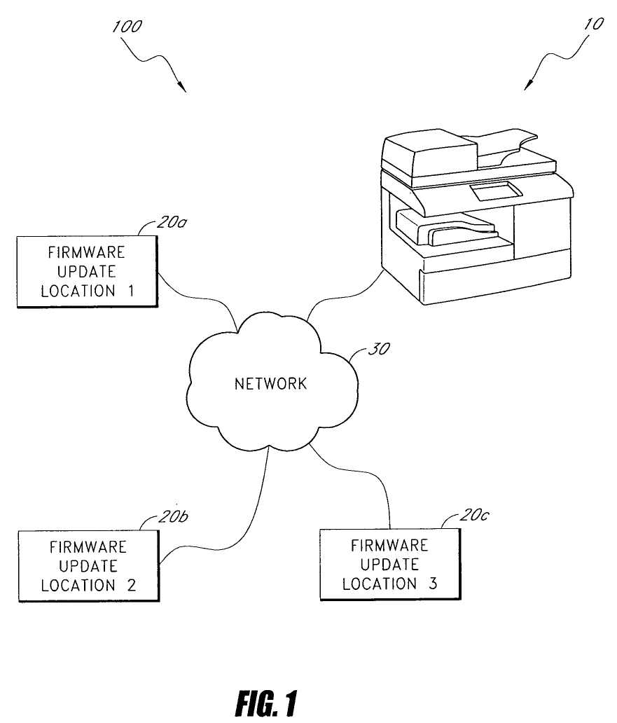

FIG. 1 illustrates a system 100 for updating firmware of a multi-function peripheral device (MFP) 10 according to one embodiment. The system 100 includes an MFP 10, one or more firmware update locations 20a, 20b, and 20c, and a network 30 interconnecting the MFP 10 and the firmware update locations 20a, 20b, and 20c.

The MFP 10 is an all-in-one office machine having various functions. The illustrated MFP 10 has functions such printing, scanning, facsimile receiving and transmitting, photocopying, and emailing. A skilled artisan will appreciate that the MFP 10 may have more or less functions, depending on the design of the MFP 10.

The MFP 10 has firmware in its non-volatile memory, for example, a read-only memory (ROM). The term, “firmware,” generally refers to a software program or set of instructions for the functions and operations of an MFP. The firmware is embedded permanently in the MFP 10, but is subject to updating.

Each of the one or more firmware update locations 20a, 20b, and 20c is configured to store a firmware update for the MFP 10. In one embodiment, the firmware update locations 20a, 20b, and 20c include a website generally run by the manufacturer of the MFP 10. In another embodiment, the firmware update locations 20a, 20b, and 20c may include a website for collecting firmware updates of various electronic devices. In yet another embodiment, the firmware update locations 20a, 20b, and 20c may include a local computer or server designated for storing firmware updates.

The firmware update locations 20a, 20b, and 20c may include a server and/or a general purpose computer. The firmware update locations 20a, 20b, and 20c store a firmware update in their non-volatile storage devices, for example, hard disks, flash ROMs, magnetic tapes, and the like. The firmware update locations 20a, 20b, and 20c may be located remotely or locally with respect to the MFP 10. In the illustrated embodiment, the system 100 is provided with three update locations 20a, 20b, and 20c. In another embodiment, the system 100 may be provided with only one update location. A skilled artisan will appreciate that the number of update locations can vary widely depending on the updating needs and system configurations.

The network 30 is configured to interconnect the MFP 10 with the firmware update locations 20a, 20b, and 20c. The network 30 may include at least one of a computer network and a telephone network. The computer network may include a wide area network (WAN), a local area network (LAN), and the Internet. The telephone network may include a private and/or public telephone networks. The network 30 may be wired or wireless. Exemplary wired network technologies include, but are not limited to, Ethernet, ISDN, and DSL. Exemplary wireless technologies include, but are not limited to, radio frequency, infrared waves, wireless personal area network (PAN) (e.g., Bluetooth®), wireless LAN (e.g., Wi-Fi), CDMA, and Satellite technologies. A skilled artisan will appreciate that various types of networks can be used for the firmware updating.

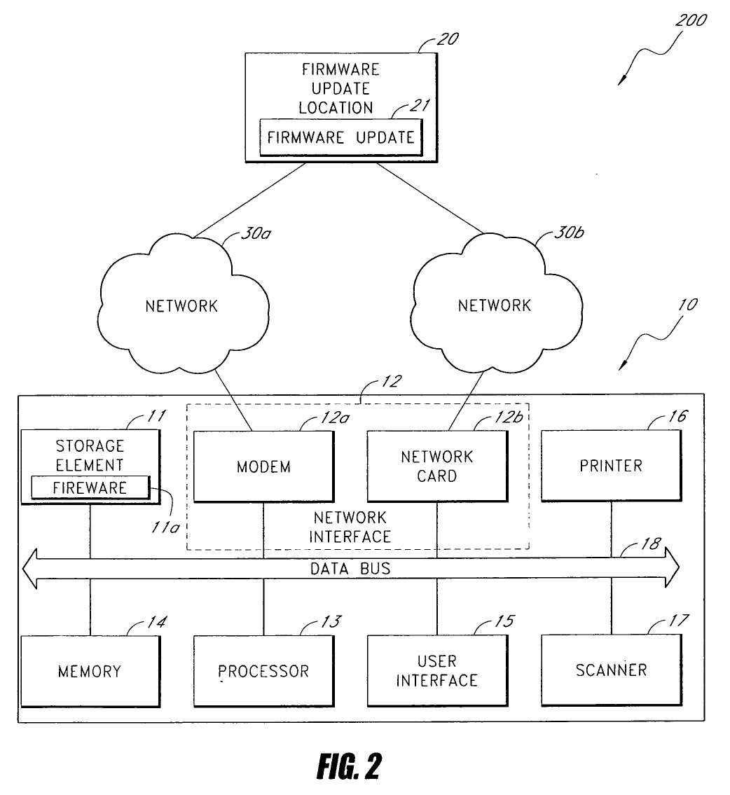

FIG. 2 illustrates a system 200 for updating a multi-function peripheral device (MFP) in accordance with another embodiment. The system 200 includes an MFP 10 connected to a firmware update location 20 via networks 30a, 30b.

The firmware update location 20 is configured to store a firmware update 21 for the MFP 10. The configuration of the update location 20 may be as described above with respect to those of the update locations 20a, 20b, and 20c of FIG. 1. In other embodiments, the MFP 10 may be provided with additional firmware update locations.

The networks 30a, 30b include a telephone network 30a and a computer network 30b. The configurations of the networks 30a, 30b may be as described above with respect to that of the network 30 of FIG. 1.

The illustrated MFP 10 includes a storage element 11, a network interface 12, a processor 13, a memory 14, a user interface 15, a printer 16, a scanner 17, and a data bus interconnecting the foregoing components with one another. It will be appreciated that some of the components may be omitted from the MFP 10 or additional components may be added to the MFP 10 depending on the design of the MFP 10.

The storage element 11 is configured to store firmware 11a of the MFP 10. The storage element 11 may be a non-volatile memory device which can store electronic data permanently while allowing modification of the data. An exemplary non-volatile memory is a re-writable read-only memory (ROM). Examples of the re-writable ROM include, but are not limited to, erasable programmable read-only memories (EPROMs) and electrically erasable programmable read-only memories (EEPROM) including flash memory. In certain embodiments, the storage element 11 may include a hard-disk. A skilled artisan will appreciate that various types of storage devices can be adapted for use in the MFP 10.

The network interface 12 is configured to interface with at least one of the networks 30a, 30b, when communicating with the firmware update location 20. The network interface 12 is also used for conducting other functions of the MFP 10, for example, faxing and emailing. The illustrated network interface 12 includes a modem 12a and a network card 12b. The network interface 12 may also include a network interfacing software program embedded therein.

The modem 12a is configured to communicate with the firmware update location 20 via the telephone network 30a. The modem 12a may receive a firmware update 21 from the update location 20 or transmit certain information to the firmware update location 20, as will be better understood from later description. The modem 12a may be one which is typically used in an MFP or a facsimile device. The modem 12a is configured to modulate an analog carrier signal to encode digital information, and is also configured to demodulate such a carrier signal to decode transmitted information. The modem 12a may also be used for the facsimile function of the MFP 10.

The network card 12b is configured to communicate with the firmware update location 20 via the computer network 30b. The network card 12b is configured to receive or download a firmware update 21 from the firmware update location 20. The network card 12b may also be used to send certain information to the firmware update location 20. The network card 12b may be one which is typically used in an MFP. The network card 12b may also be referred to as a “network adaptor,” “network interface card,” or “NIC.” The network card 12b may also be used for various other functions of the MFP 10, for example, transmitting data to a computer or receiving data from a computer over the computer network 30b. The network card 12b may also be used for the emailing function of the MFP 10.

The network interfacing software program is configured to determine whether data received at the network interface 12 is a firmware update 21 or related information. The firmware update 21 or related information may be flagged as such based on the sender or the format of the data. For example, the firmware update 21 or related information may have a file header showing that it is related to firmware updating. The network interfacing software program may also include an email processor configured to process outgoing or incoming emails having a firmware update 21 or related information. It will be appreciated that the function and configuration of the network interfacing software program may vary depending on the communication needs and design of the MFP 10. It will also be appreciated that the network interfacing software program may be embedded in the storage element 11 and run by the processor 13 to perform the functions described above.

The processor 13 is configured to perform various processes for updating the firmware 11a of the MFP 10. Details of the processes will be described later with respect to a method of updating the firmware 11a. The processor 13 is also configured to control the operation of the MFP 10 for various functions thereof. The processor 13 may comprise a CPU typically used for an MFP.

The memory 14 is configured to temporarily store a downloaded firmware update or related information therein until the update or the information is permanently stored in the storage element 11 or the update is installed to update the firmware 11a. The memory 14 may be a volatile memory such as a random access memory (RAM). The memory 14 is also used to temporarily store data used for other functions of the MFP 10, e.g., faxing, emailing, scanning, printing, and photocopying.

The user interface 15 is configured to allow a user to control the updating of the firmware 11a. Details of the updating of the firmware 11a using the user-interface 15 will be described later. The user interface 15 includes an input device and a display device. The input device may include a key pad, a key board, and/or functional buttons. The display device may include a CRT or LCD screen. In certain embodiments, the input device and the display device may be combined with each other. An exemplary combined device is a touch screen. The illustrated user interface 15 is integral with the MFP 10. In another embodiment, the user interface 15 may be connected to the MFP 10 via a USB port of the MFP 10. In yet another embodiment, the user interface 15 may be connected to the MFP 10 via a wireless connection. The wireless connection may be provided using any known wireless technology in the industry. Exemplary wireless technologies include, but are not limited to, radio frequency, infrared waves, wireless personal area network (PAN) (e.g., Bluetooth®), and wireless LAN (e.g., Wi-Fi).

The printer 16 is configured to convert electronic image data into physical documents. The scanner 17 is configured to scan physical documents and convert them into electronic image data. The printer 16 and the scanner 17 may be ones typically used for an MFP or a facsimile device. The printer 16 and the scanner 17, either alone or in combination, perform various functions of the MFP 10, for example, scanning, photocopying, printing, and faxing.

### Method of Updating Firmware

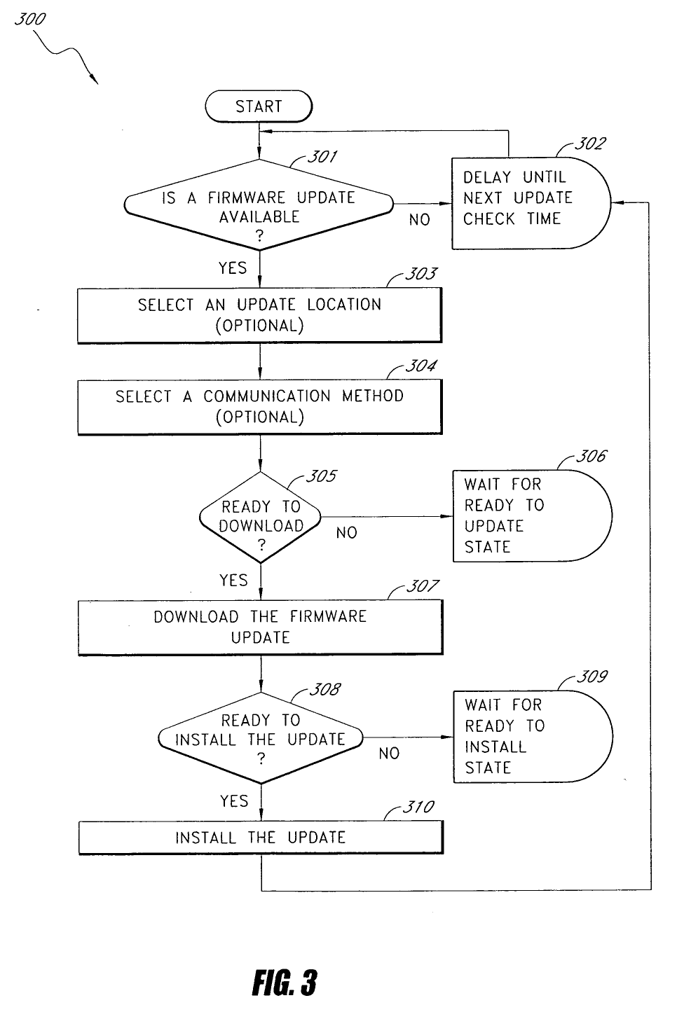

Referring to FIGS. 2 and 3, a method of updating a firmware 11a of an MFP 10 according to one embodiment is described. In the method, the updating of the firmware 11a is independently initiated and carried out at the MFP 10.

First, in step 301 of FIG. 3, the MFP 10 determines whether a firmware update 21 is available at the firmware update location 20. The firmware 11a of the MFP 10 includes version information indicating the version of the firmware 11a. The MFP 10 may send a firmware update information request to the firmware update location 20 via one of the networks 30a, 30b. In certain embodiments, the MFP 10 may select one of a plurality of firmware update locations (for example, 20a, 20b, and 20c of FIG. 1), and send the request to the selected location.

Then, the firmware update location 20 sends the MFP 10 update version information indicating the version of a currently available update 21. The MFP 10 compares the version of the update 21 with the version of the firmware 11a. If the firmware 11a of the MFP 10 has a version lower than the version of the available update 21, step 303 is carried out. Otherwise, updating is delayed until a next update check time (step 302).

In another embodiment, the processor 13 may create an update inquiry including the version information of the firmware 11a of the MFP 10. Then, the MFP 10 sends the inquiry to the firmware update location 20 via one of the networks 30a, 30b. The firmware update location 20 may determine whether the firmware 11a of the MFP 10 is up-to-date by comparing the version of the firmware 11a of the MFP 10 with that of a currently available update. If the firmware update location 20 has an update having a higher version than that of the firmware 11a of the MFP 10, it notifies the MFP 10 that an update is available. Otherwise, the update location 20 notifies the MFP 10 that the firmware 11a of the MFP 10 is up-to-date.

The MFP 10 may perform the step 301 automatically at a predetermined time interval. The updating of the firmware 11a may be initiated, for example, every week, every two weeks, every month, every two months, or every six months. The MFP 10 may be also set to initiate the updating when it is idle or when it is being turned on or off. The updating schedule may be set when the MFP 10 is manufactured. Alternatively, an administrator or user of the MFP may be allowed to modify the updating schedule.

In communicating with the update location 20, the MFP 10 may directly exchange electronic files or data with the firmware update location 20 via the computer network 30b. The electronic files or date may contain a firmware update information request, an update inquiry, or version information. In the context of this document, this type of communication may be referred to as “direct access communication.” A skilled artisan will appreciate that various network protocols can be used for communication between the MFP 10 and the firmware update location 20.

In another embodiment, the electronic files or data may be in a form of email or email attachment. In the context of this document, this type of communication may be referred to as “email communication.” The MFP 10 may generate an email with an electronic file attached thereto. Then, the MFP 10 may send the email to an email address designated to the firmware update location 20. In this embodiment, the MFP 10 may also have an email address designated thereto for a return email from the firmware update location 20. Upon receiving the email, the firmware update location 20 processes the attached request or inquiry, and returns an email containing update version or update availability information. In both of the direct access communication and the email communication, the network card 12b may be used to interface the MFP 10 with the computer network 30b. In another embodiment, the email communication method may use the telephone network 30b when exchanging emails.

In yet another embodiment, the MFP 10 may exchange the electronic files or data with the firmware update location 20 over the telephone network 30a. In the context of this document, this type of communication may be referred to as “fax communication.” In the fax communication, the format of the electronic files or data may be different from that used in the direct access or email communication. As described above with respect to FIG. 2, the modem 12a is used to interface the MFP 10 with the telephone network 30a.

In certain embodiments, the MFP 10 and the firmware update location 20 may use different communication methods from each other when one of them communicates with the other. For example, the MFP 10 may use the direct access communication whereas the firmware update location 20 may use the email communication. It will be appreciated that various combinations of the communication methods are possible based on the three communication methods described above. It will be also appreciated that the communication method can be changed by a user or administrator of the MFP 10 or an administrator of the firmware update location 20.

In addition, the MFP 10 and/or the firmware update location 20 may use different communication methods depending on the circumstances under which the electronic files or data are transmitted. For example, the MFP 10 may select which network it will use when sending an update information request or update inquiry. When sending the request or inquiry, the processor 13 checks which network is available or has less traffic. The processor 13 may determine the availability of the networks by checking how much traffic the modem 12a or the network card 12b has. In certain embodiments, the MFP 10 may have a default network for the request or inquiry. The default network may be either the telephone network 30a or the computer network 30b. In such embodiments, if the default network is busy, the processor 13 selects the other network, if available. If the other network is not available either, the processor 13 may delay sending the request or inquiry a predetermined period of time, for example, 10 minutes, 30 minutes, 1 hour, 2 hours, and the like.

In another embodiment, the firmware update location 20 may send an update message to the MFP 10 to notify that a firmware update 21 is available even without any request or inquiry from the MFP 10. Upon receiving such a message, the MFP 10 may initiate the updating of the firmware 11a. In this embodiment, the MFP 20 may still perform the step 301 to verify whether the firmware 11a of the MFP 10 is up-to-date.

In yet another embodiment, a user or administrator of the MFP 10 may manually initiate the updating of the firmware 11a. In this embodiment, the user or administrator may use the user interface 15 of the MFP 10 for updating the firmware 11a. Upon receiving instructions from the user or administrator via the user interface 15, the MFP 10 performs the step 301 as described above.

In the embodiments described above, the MFP 10 is provided with a network interfacing software program. The program is configured to determine whether files or data received at the network interface 12 are related to firmware updating. Such files or data may be flagged as such based on the sender or the format of the file or data. For example, the files may have a file header showing that it is related to firmware updating. In using the email communication, the software program may distinguish an update-related email from others based on the sender or title of the email. A skilled artisan will appreciate that various methods of flagging or detecting a firmware update or related information may be used depending on the communication methods.

Referring back to FIG. 3, in step 303, the MFP 10 may optionally select one of a plurality of firmware update locations 20 for downloading the firmware update 21. For example, as shown in FIG. 1, the MFP 10 may be provided with a plurality of firmware update locations 20a, 20b, and 20c. The MFP 10 may select one of the locations 20a, 20b, and 20c depending on the availability and traffic of the locations. The update location for downloading may be the same as or different from the update location for the update information request or update inquiry described above with respect to step 301. In certain embodiments, the MFP 10 may have a default update location and may change the update location only under exceptional circumstances. In other embodiments, the MFP 10 may allow a user to select an update location via the user interface 15, which will be better understood from later description.

In step 304, the MFP 10 may optionally select one of a plurality of communication methods. As described above with respect to the update information request or update inquiry, the MFP 10 may be provided with the three communication methods: the direct access, email, and fax communication. It will be appreciated that any other suitable communication methods may be adapted for communication between the MFP 10 and the update location 20.

The MFP 10 may choose one of the communication methods for downloading the firmware update depending on the traffic of the networks and/or the update location selected in step 303. The communication method for downloading may be the same as or different from that for the update information request or update inquiry described above with respect to step 301. In certain embodiments, the MFP 10 may have a default communication method and may use another only under exceptional circumstances. In other embodiments, the MFP 10 may allow a user to select a communication method via the user interface 15, which will be better understood from later description. In certain embodiments, the steps 303 and/or 304 may be omitted.

Then, in step 305, the MFP 10 inquires whether it is ready to download the firmware update 21 from the selected firmware update location 20 via the selected communication method 30. If the downloading is ready to proceed, the firmware update 21 is downloaded from the update location 20 to the MFP 10 (step 307). Otherwise, the MFP 10 may delay the downloading a predetermined period of time, for example, 10 minutes, 30 minutes, 1 hour, 2 hours, and the like (step 306), and check again whether the downloading is available. In certain embodiments, if the downloading is not ready to proceed, the MFP 10 may optionally go back to steps 303 and 304 to seek an immediately available update location or communication method for downloading the firmware update 21.

In step 307, the firmware update 21 is downloaded from the selected update location 30 via the selected communication method. In an embodiment where the email communication is employed, the firmware update 21 is sent by the firmware update location by email rather than being downloaded therefrom. In such an embodiment, steps 303 through 307 may be replaced with a single step of sending an update email from the firmware update location 20 to the MFP 10.

In certain embodiments, the firmware update 21 transmitted over the network 30a, 30b may be encrypted for security concerns. The firmware update 21 may contain confidential information regarding security features of the MFP 10. In such instances, the firmware update 21 may be encrypted using any suitable data encryption method. The MFP 10 is then provided with a decryption software program for decrypting an encrypted firmware update 21.

The downloaded update is temporarily stored in the memory 14 of the MFP 10. In certain embodiments, the downloaded update is permanently stored in a non-volatile storage device such as a hard-disk until the update is installed to update the firmware 11a.

In step 308, the MFP 308 inquires whether the downloaded update is ready to install. If the MFP 308 is not in use, the update may be installed, thereby updating the firmware 11a (step 310). The version information of the firmware 11a is also updated according to the version information of the update being installed. Then, updating of the firmware 11a is not initiated until a next update check time (step 302). In certain embodiment, the MFP 308 may allow a user to approve the installation of the update. For example, a user may want to delay the installation if the update contains certain features that the user does not desire to have until later. Details of the user approval will be described later.

If, however, the MFP 308 is in use and the installation of the update may affect the operation of the function being used, the installation is delayed a predetermined period of time (step 309). After elapse of the period, the MFP 308 inquires again whether the update is ready to install.

### User Interfacing for Updating Firmware

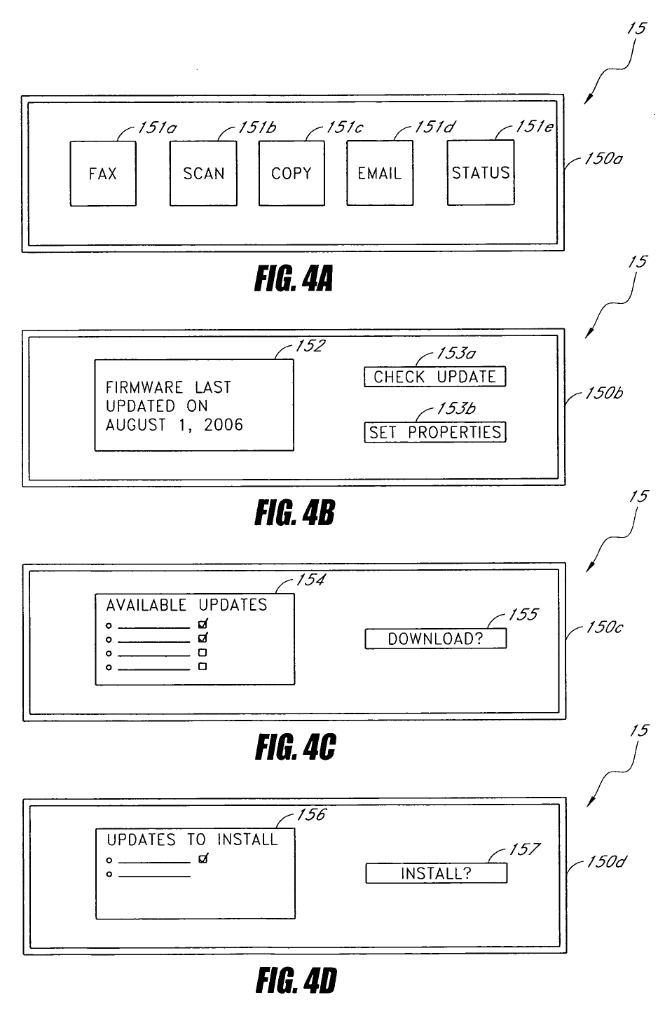

FIGS. 4A-4D illustrate a user interface 15 of the MFP 10 (FIG. 1) for updating the firmware according to one embodiment. The illustrated user interface 15 is a touch screen display which serves both as a display device and as an input device. In addition, the MFP 10 may be provided with other input devices (not shown) such as a keypad, a keyboard, and/or various functional buttons.

Referring to FIG. 4A, an initial screen 150a of the user interface 15 is described. The initial screen 150a displays selection buttons 151a-151e for various functions of the MFP 10. The illustrated selection buttons include a “FAX” button 151a, a “SCAN” button 151b, a “COPY” button 151c, an “EMAIL” button 151d, and a “STATUS” button 151e. A user may simply touch a button which indicates a desired function. Alternatively, the user may press a directional key or button of the MFP 10 to select one of the functions.

A user may check the update status of the firmware of the MFP 10 by touching the status button 151e. Although not shown, the user interface 15 may display an additional menu screen which displays various other status selection buttons when the status button 151e has been touched. The user may be then required to touch a button for the firmware update status.

FIG. 4B illustrates a firmware status screen 150b according to one embodiment. The firmware status screen 150b includes a status window 152 and selection buttons 153a, 153b.

The status window 152 displays the current update information of the firmware 10. The current update information may include the last updating date and the version of the firmware. It will be appreciated that additional information may be displayed on the status window 152.

The selection buttons may include a “CHECK UPDATE” button 153a and a “SET PROPERTIES” button 153b. The “CHECK UPDATE” button 153a, if touched, initiates the updating of the firmware. For example, the method of FIG. 3 is triggered, i.e., the MFP 10 sends an update information request to the firmware update location 20. The “SET PROPERTIES” button 153b, if touched, opens a pop-up window or another menu screen. The pop-up window or menu screen displays various properties for firmware updating. Examples of such properties include, but are not limited to, a frequency or time interval for triggering updating, a default firmware update location, a default communication method, a default network, and automatic/manual update initiation. A skilled artisan will appreciate that the user interface 15 may allow a user to change various other properties with respect to updating the firmware.

FIG. 4C illustrates an update availability information screen 150c. The update availability information screen 150c includes an update availability window 154 and a “DOWNLOAD” button 155. The MFP 10 obtains update availability information from a selected firmware update location 10 as described above with respect to the step 301 of FIG. 3. Then, the MFP 10 displays the information on the update availability window 154. The illustrated update availability window 154 displays currently available updates and check boxes on the right side of each of the available updates. This configuration allows a user to select a desired update while opting out of undesired ones. In another embodiment, the user may obtain additional information about a specific update by touching the update on the window 154. Then, a pop-up window appears on the screen 150c and displays the information related to the update. In yet another embodiment, the window 154 may not allow a user to opt out of a certain update if the update has been determined to be necessary by the manufacturer.

A user may now touch the “DOWNLOAD” button 155, which triggers downloading of the selected updates from the firmware update location 20. As described above with respect to FIG. 3, the user may be allowed to select an update location 20 and a communication method after touching the “DOWNLOAD” button 155. In other embodiments, the MFP 10 carries out the downloading under a default setting.

FIG. 4D illustrates an installation screen 150d displayed after the downloading of the firmware has been completed. The installation screen 150d includes an updates-to-install window 156 and an “INSTALL” button 157. The window 156 displays downloaded updates and check boxes on the right side of each of the updates. A user may select a desired update while opting out of an undesired one. Similar to the update availability window 154, the user may obtain additional information about a specific update by touching the update on the updates-to-install window 156. In certain embodiments, the window 156 may not allow the user to opt out of a certain update if the update has been determined to be necessary by the manufacturer. The user, after selecting updates, may simply touch the “INSTALL” button 157 to install the selected update.

In the illustrated embodiment, a user is allowed to initiate and control the updating of the firmware of the MFP 10. In other embodiments, a user may only set properties for automatic updating, and the MFP 10 carries out the updating without involvement of the user. In certain embodiments, the manufacturer may optimize updating properties, not allowing a user to change the properties. A skilled artisan will appreciate that various configurations of user-involved updating are possible.

According to the embodiments described above, the firmware of the MFP 10 can be independently updated without help of a computer. Since the MFP 10 can independently check update availability and download updates from an update location, a separate computer having the ability is not required. In addition, a user does not have to install an MFP updating software on a computer which otherwise needs to have one installed thereon for updating an MFP.

The foregoing description is that of embodiments of the invention and various changes, modifications, combinations and sub-combinations may be made without departing from the spirit and scope of the invention, as defined by the appended claims.

What is claimed is:

1. A multi-function peripheral (MFP) device, comprising:
a storage element configured to store firmware;
a network interface configured to establish a data connection with a firmware update location via a network; and
a processor configured to download a firmware update from the firmware update location via the network and configured to install the firmware update in the storage element, thereby updating the firmware.

2. The device of claim 1, wherein the network interface comprises a modem connectable to a telephone network.

3. The device of claim 1, wherein the network interface comprises a network card connectable to a computer network.

4. The device of claim 1, wherein the network interface is further configured to determine whether data received via the network is a firmware update from the firmware update location.

5. The device of claim 1, wherein the network interface is further configured to establish a data connection with one of a plurality of firmware update locations, and wherein the processor is configured to select one of the firmware update locations for downloading the firmware update.

6. The device of claim 1, wherein the network interface is configured to interface with a plurality of networks, and wherein the processor is configured to select one of the networks for downloading the firmware update.

7. The device of claim 1, wherein the processor is further configured to send a firmware update information inquiry to the firmware update location.

8. The device of claim 1, wherein the processor is further configured to determine whether the firmware of the MFP requires updating.

9. The device of claim 8, wherein the processor is further configured to automatically determine whether the firmware of the MFP requires updating.

10. The device of claim 9, wherein the processor is further configured to periodically determine whether the firmware of the MFP requires updating.

11. The device of claim 1, wherein the processor is further configured to download the firmware update upon receiving an update message provided from the firmware update location.

12. The device of claim 1, further comprising a user interface configured to allow a user to set properties for downloading of a firmware update.

13. The device of claim 1, further comprising a user interface configured to allow a user to approve the downloading of the firmware update or the installing of the firmware update.

14. A multi-function peripheral (MFP) device, comprising:
means for storing firmware;
means for establishing a data connection with a firmware update location via a network; and
means for downloading a firmware update from the firmware update location via the network and for installing the firmware update, thereby updating the firmware.

15. A system for updating firmware of a multi-function peripheral (MFP) device, comprising:
at least one firmware update location configured to store a firmware update;
at least one network; and
an MFP comprising:
a storage element configured to store firmware;
a network interface configured to establish a data connection with the at least one firmware update location via the at least one network; and
a processor configured to download the firmware update from one of the at least one firmware update location via one of the at least one network and configured to install the firmware update in the storage element, thereby updating the firmware.

16. The system of claim 15, wherein the at least one network comprises a telephone network.

17. The system of claim 16, wherein the network interface comprises a modem connected to the telephone network.

18. The system of claim 15, wherein the at least one network comprises a computer network.

19. The system of claim 18, wherein the network interface comprises a network card connected to the computer network.

20. The system of claim 15, wherein the network interface is configured to communicate with one of the at least one firmware update location by one of a fax communication method, a direct access communication method, and an email communication method.

21. The system of claim 15, wherein the network interface is further configured to determine whether data received via the network is a firmware update from the at least one firmware update location.

22. The system of claim 15, wherein the processor is further configured to send a firmware update information inquiry to the at least one firmware update location.

23. The system of claim 15, wherein the processor is further configured to determine whether the firmware of the MFP requires updating.

24. The system of claim 23, wherein the processor is configured to automatically determine whether the firmware of the MFP requires updating.

25. The system of claim 24, wherein the processor is configured to periodically determine whether the firmware of the MFP requires updating.

26. The system of claim 15, wherein the processor is configured to download the firmware update upon receiving an update message provided from the at least one firmware update location.

27. The system of claim 15, wherein the at least one firmware update location comprises a plurality of firmware update locations, and wherein the processor is configured to select one of the firmware update locations for downloading the firmware update.

28. The system of claim 15, wherein the at least one network comprises a plurality of networks, and wherein the processor is configured to select one of the networks for downloading the firmware update.

29. The system of claim 15, wherein the MFP further comprises a user interface configured to allow a user to set properties for downloading the firmware update.

30. The system of claim 15, wherein the MFP further comprises a user interface configured to allow a user to approve the downloading of the firmware update or the installing of the firmware update.

31. A method of updating firmware of multi-function peripheral device (MFP), the method comprising:
determining whether to update firmware of an MFP at the MFP;
connecting the MFP to a firmware update location via a network, the firmware update location storing a firmware update;
downloading the firmware update from the firmware update location to the MFP; and
installing the firmware update, thereby updating the firmware.

32. The method of claim 31, wherein the network comprises at least one of a telephone network and a computer network.

33. The method of claim 31, wherein determining whether to update the firmware comprises:
sending a firmware update information request from the MFP to the firmware update location;
sending update version information from the firmware update location to the MFP; and
comparing the update version information with version information of the firmware of the MFP at the MFP.

34. The method of claim 31, wherein determining whether to update the firmware is automatically initiated at the MFP.

35. The method of claim 34, wherein determining whether to update the firmware is periodically initiated at the MFP.

36. The method of claim 31, further comprising sending an update message from the firmware update location to the MFP prior to determining whether to update the firmware, wherein determining whether to update the firmware is initiated upon receiving the update message.

37. The method of claim 31, wherein the firmware update is received through one of a fax communication method, a direct access communication method, and an email communication method.

38. The method of claim 31, further comprising determining whether data received via the network is a firmware update from the firmware update location.

39. The method of claim 31, further comprising providing a plurality of firmware update locations, wherein connecting the MFP to the firmware update location comprises selecting one of the firmware update locations.

40. The method of claim 31, further comprising providing a plurality of networks, wherein connecting the MFP to the firmware update location comprises selecting one of the networks.

41. The method of claim 31, further comprising allowing a user to set properties for determining whether to update the firmware or properties for downloading the firmware update.

42. The method of claim 31, further comprising allowing a user to approve the downloading of the firmware update or the installing of the firmware update.
